(19) United States
(12) Patent Application Publication
(10) Pub. No.: US 2003/0229509 A1
(43) Pub. Date: Dec. 11, 2003

(54) Risk management system

(76) Inventors: William Hall, Chula Vista, CA (US); Michael Stearns, Junneau, AK (US); Paul Cassani, El Cajon, CA (US); Owen O'Brien, San Diego, CA (US)

Correspondence Address: BROWN, MARTIN, HALLER & MCCLAIN LLP, 1660 UNION STREET, SAN DIEGO, CA, 92101-2926, US

(21) Appl. No.: 10/413,634

(22) Filed: Apr. 14, 2003

Related U.S. Application Data
(60) Provisional application No. 60/372,692, filed on Apr. 12, 2002.

(51) Int. Cl. G06F 17/60

(52) U.S. Cl. 705/1

(57) ABSTRACT

In the risk management system of the present invention, an inspector utilizes a personal digital assistant to assess the condition of inspection points on a structure, such as a steel marine structure. The inspection points are subjected to environmental conditions such as seawater, air, elevated temperatures, chemicals and operational stresses, all of which can have a direct influence on the structure's building media (steel). The PDA is pre-loaded with the risk management system which is comprised of one or more previously quantified drop down menus or boxes from which an inspector can choose defined selections. Based upon initial selections by the inspector, such as defining the location and environment of the structure, the system determines how the drop down box will be populated. The inspector selects the item in the menu box that best categorizes the status of each inspection point. Once the inspection is complete, each inspection point is compared on an objective normalized standard within the system, removing the element of subjectivity associated with condition surveys.

### CROSS-REFERENCES TO RELATED APPLICATIONS

This application claims the benefit of priority of U.S. provisional application Serial No. 60/372,692 filed Apr. 12, 2002 which is incorporated herein by reference in its entirety.

### BACKGROUND OF THE INVENTION

Marine structures are continually subjected to some of the harshest operating environments on earth. The staple building material used in these structures, carbon steel, although a robust versatile building medium, has the natural tendency to revert back to its original state by the electrochemical process known as corrosion.

In addition to the natural corrosion process, marine structures are subjected to continual stresses exerted on the structure by wind speeds ranging from calm to 100+MPH and in many regions 20-30 foot and higher seas are not uncommon, exerting several types of stress, such as sheer impact, torsional, vibratory and inertial stresses, simultaneously on the structure. These compound stresses emerge as fracture and/or bending and buckling of structural elements and plate in the structure.

To prevent these operational stresses from tearing the structure apart, naval architects integrate various large and small support members within the structure to give the structure geometric strength. Thus, the typical marine structure has a high degree of internal complexity, which has a profound influence on assessing the condition of these structures in two ways:

(1) COMPLEXITY: Due to the intensity of longitudinal, transverse, vertical, horizontal and diagonal oriented support elements throughout the structure, many surfaces are both difficult and time consuming to access and survey.

(2) OVERALL SURFACE AREA: On many marine structures, surface area can be expressed in terms of miles and acres. For example: It has been estimated that the average 250,000 DWT VLCC (Very Large Crude Carrier) contains approximately 35 miles of structural longitudinals that form a skeletal structure of the hull and a total surface area of approximately 75 acres. Although many marine structures have significantly less area, many in fact have significantly more.

Due to the logistical challenges of a limited time frame, considerable size and complexity, risk assessment on a working marine structure becomes an exercise of identifying, cataloging, weighing and calculating acknowledged risks. Additionally, unless preventative measures are executed once an anomaly such as a corrosion site or fracture develops, it is always associated with decreasing strength in the area, which by its nature will continue to decrease as the structure ages.

On a working marine structure it is not possible to correct every condition that exists. Therefore, conditions must be categorized, prioritized and a level of risk calculated based on predetermined criteria of categorizing the criticality of specific conditions in a specific location on a specific type of marine structure.

To maximize the benefit of a risk assessment system, the actual survey that serves as the point of reference for the risk assessment must contain the appropriate information for the structure being inspected. However, prior marine surveys often do not cover the range of issues necessary to make a determination of the actual level of risk and the appropriate options to effectively address a structure's current condition and provide an accurate and practical projected condition analysis based specifically on the structure's function and commercial value, i.e., daily revenue producing value, charter schedule, etc.

Condition surveys often lack the perspective of considering relational influence of potential contributing factors such as, but not limited to structural corrosion, paint and cathodic conditions that may be present on the structure being surveyed. Instead information generated during a survey is often too focused on a surveyor's individual specialty, i.e., steel condition, steel thickness gauging, paint condition or cathodic protection; consequently, the survey data can become too focused, over emphasizing some conditions while under emphasizing other conditions that may be important in determining the condition of the structure. The data or documentation generated can be too extensive or complex on one condition, and too vague on other conditions that could, in fact, be a primary consideration in forming an effective maintenance strategy. Condition surveying is, to some degree, subjective. Therefore, the conclusions of a condition survey can vary widely from surveyor to surveyor. This can result in erratic maintenance strategies over extended periods. Often, survey results do not give full consideration to the specific type of structure surveyed. Text based reports can be inconsistently formatted and time intensive to prepare, increasing the survey report's delivery time and cost.

### SUMMARY OF THE INVENTION

In the risk management system of the present invention, an inspector utilizes a personal digital assistant (PDA), such as a Palm Pilot™, to assess the condition of inspection points on a structure, such as a steel marine structure. The inspection points are subjected to environmental conditions such as seawater, air, elevated temperatures, chemicals and operational stresses, all of which can have a direct influence on the structure's building media (steel). The PDA is pre-loaded with the risk management system which is comprised of one or more previously quantified drop down menus or boxes from which an inspector can choose defined selections. Based upon initial selections by the inspector, such as defining the location and environment of the structure, the system determines how the drop down box will be populated. The inspector selects the item in the menu box that best categorizes the status of each inspection point. Once the inspection is complete, each inspection point is compared on an objective normalized standard within the system, removing the element of subjectivity associated with condition surveys. The same conclusion will be reached in assessing an inspection point regardless of who the inspector is.

The system of the present invention comprises the following steps:

1. Owner of the structure provides general characteristics of the structure.

2. General characteristics are either keyed in or imported in electronic form into the risk management system that resides in a host PC. These characteristics are then loaded into a database on a PDA.

3. An inspector visits a site of a structure that is to be inspected.

4. Using the system installed on a PDA, the inspector enters or selects (depending on the level of detail provided in 1. & 2.) information such as the name of the structure and the type of structure, such as an oil tanker or a military ship.

5. Based upon the information entered in the PDA by the inspector, the system presents questions about the nature of the inspection point, for example the current condition of a weld. The current condition of the inspection point is selected from a drop down box selection that represents the condition found by the inspector.

6. The system assigns an assessed value to the condition.

7. Step 5 is repeated for each inspection point.

8. Those values are then subjected to a risk assessment calculation that determines a risk value based on the degree of damage or corrosion and the location of the inspection point, which is then prioritized by a risk value to define which inspection points pose the higher risks and therefore have to be repaired or replaced first.

The system is based on the recognition that two inspection points with the same degree of corrosion or damage can pose quite different degrees of risk, depending on where each is located on the overall structure.

The system of the present invention is applicable to commercial ships, U.S. Navy ships as well as other marine structures and other corrosion susceptible structures including civil engineering structures, such as bridges and buildings, and chemical structures, such as storage tanks and process equipment.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 shows a flow chart illustrating the process of obtaining the risk assessment of a structure;

FIG. 2a shows a condition matrix illustrating the conditions or levels of risk that can be associated with an inspection point;

FIG. 2b shows a matrix illustrating the general, structural, corrosion and coating conditions on tanks surveyed during the inspection of a structure;

FIG. 2c shows a matrix illustrating the general, structural, corrosion and coating conditions after completing repairs indicated in alternative 1;

FIG. 2d shows a matrix illustrating the repairs associated with alternative 1;

FIG. 3 shows the maximum level of risk associated with the structure;

FIG. 4 shows a bar graph illustrating the maximum level of risk compared to the surveyed level of risk of inspection points;

FIG. 5 shows a bar graph illustrating the comparison of anomalies associated with each inspection point;

FIG. 6a shows a bar graph comparing the weighted level of risk for inspection points with the completion of repairs indicated in alternatives 1-4; and

FIG. 6b shows a bar graph illustrating the level of risk associated with each inspection point after completing the repairs in alternative 1.

### DETAILED DESCRIPTION OF THE DRAWINGS

Structures deteriorate over time from many causes. The deterioration can include, but is not limited to structural, corrosion and coating deterioration. Structural deterioration can be caused from outside influences, such as a storm, or the wearing out of inspection points, such as parts or spaces on the structure. Corrosion deterioration creates the loss of structural design strength due to depletion. In many areas of the structure, this will eventually lead to the loss of structural integrity that will influence the ability of the structure to perform its overall function. Coating deterioration is the weakening of coating applied to specific areas of the structure.

The risk management system of the present invention evaluates the inspection points on a structure to determine the level of risk associated with the inspection point having a condition or anomaly, such as the deterioration previously described, if not corrected or repaired. Furthermore, the risk management system consistently and uniformly distinguishes high priority condition issues from moderately and relatively minor condition issues on a normalized basis. This is what distinguishes the system from prior art databases intended for assessing risks on the market today. The risk management system of the present invention is designed to allow the structure's owner/operator to supply general characteristics about the ship. In the case of a ship, these general characteristics can include length of structure, when it was built, what class society it is registered with, the frame number, the number of tanks, the types of tanks, etc.

In an exemplary embodiment, the risk management system of the present invention is implemented as part of a marine ship. Those skilled in the art will recognize that the principles and teachings described herein may be applied to a variety of applications or industries including civil engineering structures, such as bridges and buildings, airplanes and chemical related structures, such as storage tanks and process equipment to name just a few. However, using this system on other structures will require repopulation of certain data fields or drop down boxes.

Ships in many sectors of commercial shipping are required to maintain a class status. Class status is achieved and maintained under the guidelines of one of several class societies worldwide. Class societies belong to an association known as the International Association of Classification Societies (IACS). Without this class society classification, a ship is unable to obtain insurance and/or meet various flag state/governmental requirements worldwide. In addition, typically a charter involving the transportation of petroleum or petroleum products requires the satisfactory completion of OCIMF SIRE Vetting in order to meet the requirements of a charter. Therefore, without meeting the requirements of class and in many cases the additional requirements of vetting, it is not possible to operate a ship without operating and maintaining the structure in compliance with class standards. At a minimum, class societies are required to adhere to a set of IACS standards provided in a document known as Requirements Concerning Survey & Certification. Individual class society's standards often exceed those of IACS, but the general guidelines are fundamentally consistent with each other. Standards and regulations vary for different types of ships, i.e. the standards and regulations for a cruise ship are different than that of an oil tanker. By indicating the type of ship in the risk management system, the class rules, i.e. standards and regulations, that pertain to that type of ship are invoked.

The risk management system accomplishes risk management in much the same manner as the reasoning process a person uses when drawing a conclusion. As with the human reasoning process, a cause and affect (if/then) line of reasoning occurs based on a knowledge base the person has of the subject matter. The system's knowledge base contains thousands of structure sensitive questions and a selection of possible answers. For instance, using the example of a ship, a checklist starts by asking what type of ship (e.g., warship, merchant ship, etc.), then what type (e.g. tanker, passenger, etc.) and the checklist begins to self assemble based on the selections made. The initial data selections made cause the checklist to self populate itself with questions pertaining to conditions anticipated to be found in the structure. To the left of each question is a drop down box of possible answers. When a selection is made based upon the condition of an inspection point, the selected answer becomes a data point and when applicable, further populates the checklist. This structure condition sensitive approach of a self-assembling checklist helps to navigate or direct the survey based on actual conditions found in the space being surveyed or inspected while the inspection is underway.

The versatility of the system is attributed to the detail of the if/then technical library resident within the system. Every question is linked to an answer by interweaving thousands of if/then equations, when the surveyor or inspector makes a selection the system queries itself until the criteria lines up, when it does, it generates an answer. Since the system is based on a systematic and predetermined if/then process of elimination, the system will generate consistent data based on a given set of circumstances that lines up with class society and/or owner operator maintenance philosophies.

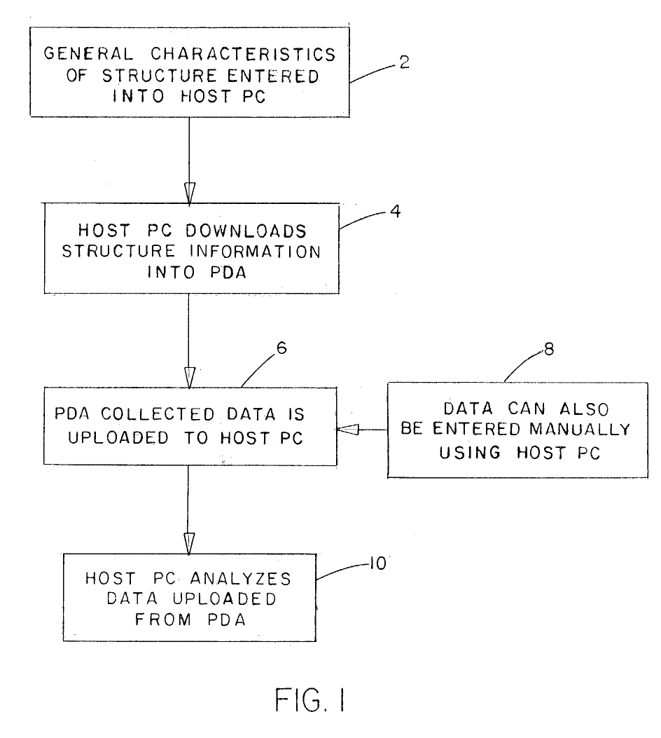

FIG. 1 shows a flow chart illustrating the process of obtaining the risk assessment of a structure. First, the owner of the structure, in this case a marine ship, supplies general characteristics of the structure which are then entered into a database on a computer or host PC 2. General characteristics can be very exhaustive or very vague and, as described previously, can include the length of the ship, when the ship was built, what class society the ship is registered with, frame numbers of the ship, the number of tanks, the types of tanks, etc. Once entered into the database within the host PC, the characteristics are then downloaded into a PDA database 4. Based upon the characteristics, initial data selections are generated. Making the initial data selection causes the system to self populate itself with questions pertaining to conditions anticipated to be found in the structure or of the anomaly or the type of damage that was registered. A response to one question will generate other questions associated with that anomaly. After all the data from each inspection point is collected, the data is then uploaded to the host PC 6. Alternatively, the collected data can be manually entered into the host PC 8. Once the data is uploaded from the PDA, the host PC analyzes the data 10 and displays the risk assessment of the ship.

When the PDA has been loaded with the characteristics of the ship, an inspector visits the ship in order to carry out the inspection. The inspector first enters the name and selects the type of ship on the PDA. Based upon the type of ship entered, the risk assessment system generates potential issues or conditions (anomalies) that are imbedded within the PDA database that are specific to the type of ship selected. Furthermore, the general characteristics provide the locations of the inspection points to be inspected. If the type of ship is an oil tanker, all of the class rules that pertain to an oil tanker are invoked. The risk assessment system builds upon itself, so once the type of ship is identified, the inspector will be asked to identify his present location and what kind of anomaly (damage) or condition that the inspector has found. For example, if the inspector sees a fracture in the ship, based upon what kind of ship it is, the risk assessment system is going to indicate to the inspector how this fracture is to be judged. In other words, whether the fracture is going to be judged by the standards of the U.S. Coast Guard, judged by class, judged by the owner's discretion, etc. Based upon this information, data fields are going to be populated and the results of the data fields are drop down selections that are offered in the PDA. The inspector repeats the process for each inspection point and all the data collected is stored in the PDA.

Within the PDA is a serious of tens of thousands of conditions and the results of those conditions. For example, when an inspector selects corrosion as the condition or anomaly associated with a particular inspection point, the inspector is then presented with a drop down menu with all the possible results (or types of corrosion) for that condition. If the corrosion is found on a surface that meets the criteria of “substantial corrosion” as defined by the standards and regulations, the result is “substantial corrosion” an IACS term, meaning that the inspection point has lost 75% of a wastage allowance that is predefined by area and class. Additional information collected includes severity or the extent of the condition and the logistics of the condition, i.e. location, condition, digital photo, and/or type of adjacent tank, etc. The system provides the technical definitions of conditions and results, such as corrosion, if the inspector does not know or cannot remember how the condition or result is defined. Typically a definition button is located next to the drop down menu. Selection of the definition button displays the standards and regulations for the particular condition or result allowing the inspector to properly judge the condition.

Once all the data from the inspection points has been collected, the PDA is plugged into the host PC and the information about the inspection points stored on the PDA database is uploaded to the host PC. The host PC contains not only the conditions and results stored in the PDA database but also solutions to those conditions. In other words, to each one of those conditions and results there is a given solution(s). During the analysis, the system finds the condition and corresponding result uploaded from the PDA and then searches for a parity of solution. The solution indicates the chronological detailed steps necessary to fix the anomaly or condition and thereby reducing risk.

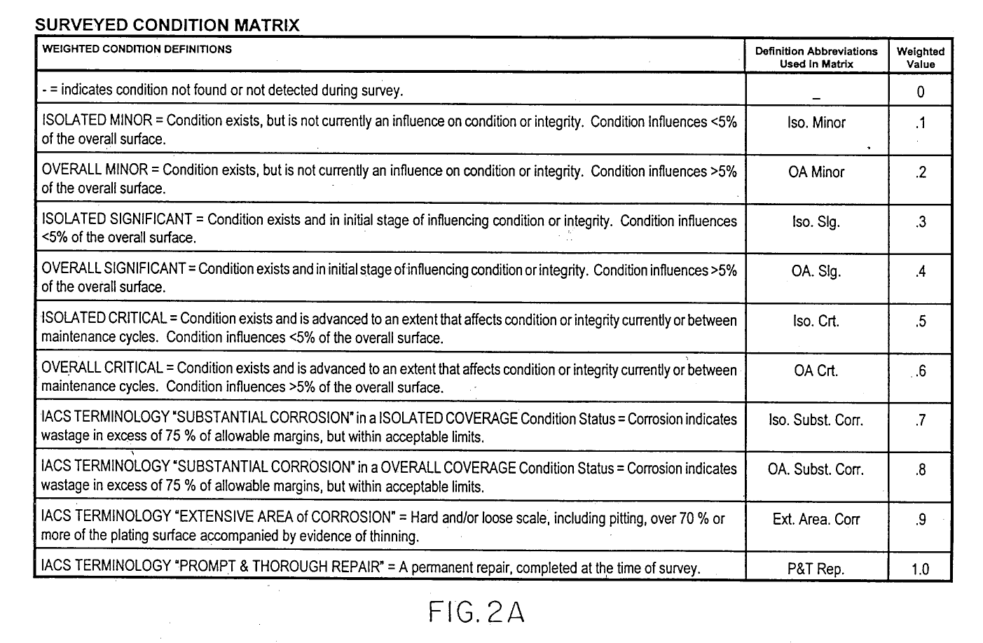

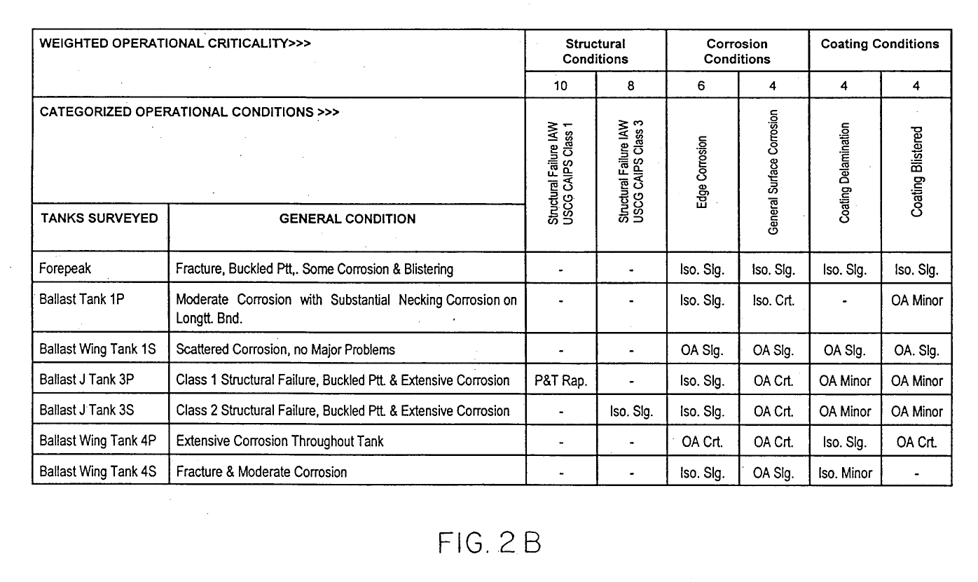

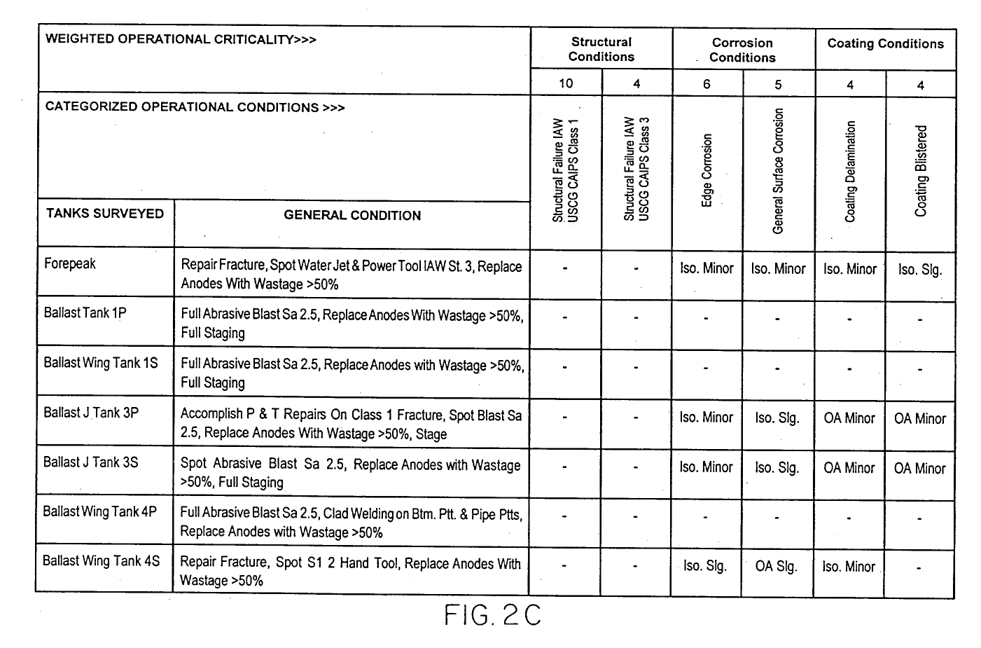

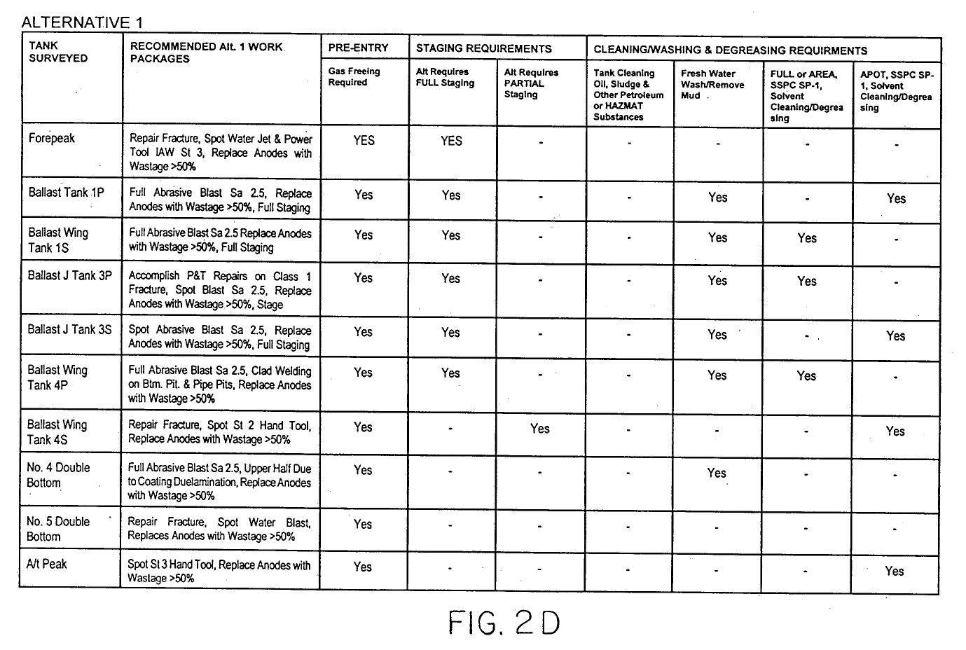

After collecting all the data, the host PC determines the risk associated with each anomaly. The associated risk can be displayed in many forms including tables, matrices and charts. FIG. 2A is a condition matrix illustrating the conditions or levels of risk that can be associated with an inspection point in the exemplary embodiment. The levels of risk can be tailored to the specifics of the structure. The conditions range from isolated minor, where the condition influences less than 5% of the overall surface, to Prompt and Thorough Repair, where the condition requires an immediate repair. Associated with each condition is a weighted value ranging from 0-1 depending on the condition or anomaly found. 0 indicates that there is no condition, 1 indicates that the condition is isolated minor and 1 indicates that the condition requires prompt and thorough repair and is a high risk.

Based upon the conditions and results identified by the inspector, the host PC can display the results in the form of a matrix that illustrates the general, structural, corrosion and coating conditions on inspection points, such as tanks, surveyed during the inspection of the structure. This matrix, illustrated in FIG. 2B, identifies the inspection points and the general condition of the inspection points as well as also indicates the potential structural, corrosion and coating anomalies for each inspection point and indicates the condition and severity of any anomalies associated with the inspection point. The matrix also provides an overall view of the conditions of the inspection points of the structure, such as Isolated Minor, and indicates the weighted operational criticality of the inspection point. The weighted operational criticality indicates how critical the inspection point is to the operations of the structure. For example, the Ballast Wing Tank 4P contains extensive corrosion throughout the tank with edge corrosion having an OA Sig or Overall Significant Condition. 7 inspection points are shown by way of example and additional inspection points can be displayed as selected by the owner/operator of the ship.

Upon generating the matrix identifying the conditions at the various inspection points, the system also generates multiple work packages or alternatives which detail the steps required to correct the anomaly. In the preferred embodiment, the system generates four alternatives to correct the anomaly with each alternative posing a different level of risk and time and cost associated with the correction. Alternative 1 results in the lowest risk level, however, it typically requires the highest level of work, time and cost involved in the repair. Alternative 4 results in the highest risk level, however, it typically requires the lowest level of work, time and cost in the repair. Alternatives 2 and 3 provide intermediate levels of risk, time and cost. Based upon the amount of time and money the owner of the ship wants to invest, as well as the level of risk that he is willing to take, he can opt for one of the four alternatives in repairing the anomaly on the ship. In an additional embodiment, the system can generate more or less than four alternatives.

FIG. 2C shows a matrix illustrating the general, structural, corrosion and coating conditions after completing repairs indicated in alternative 1. As can be seen in FIG. 2C, performing the repairs outlined in alternative 1 corrects all the conditions or anomalies associated with the Ballast Wing Tank 1S. FIG. 2D shows a matrix illustrating the detailed repairs associated with alternative 1. For example, the No. 5 Double Bottom inspection point has a work package that indicates that the fracture is to be repaired, a spot water blast is to occur and anodes are to be replaced with wastage>50% and one of the requirements required in completing the repairs associated with alternative 1 is gas freeing. The requirements in FIG. 2D are illustrative of an example of the requirements for one alternative and not meant as an inclusive list.

As described previously, the associated risks can be displayed in many ways. Furthermore, the associated risk can be displayed by a specific area of the structure, such as all deck maintenance regardless of space or by specific conditions found during the inspection. Table 1 below indicates the space name, the space number, the order of precedence for maintenance and the weighted scores associated with the anomalies in a particular space. In Table 1, the Fan Room has a weighted score of 10 which is higher than the weighted score of the other spaces listed. As a result, repairs to the fan room should take precedence over the other conditions listed as it poses the most risk to the structure.

TABLE 1

| | | Order of | Weighted Score |
|---|---|---|---|
| Space | Space | Precedence for | of Anomalies |
| Name | Number | Maintenance | in Space |
| Fan Room | 02-21-2-Q | 1 | 10 |
| Vestibule | 1-255-1-Q | 2 | 9.4 |
| Conveyor No. | 6-199-1-Q | 3 | 4.8 |
| 12 | | | |
| Tool Room | 1-253-1-Q | 4 | 3.6 |
| Boiler Room | 4-239-2-Q | 5 | 2.4 |
| Handling Area | 4-54-0-M | 6 | 2.1 |
| Deck | 1-113-2-Q | 7 | 1.5 |
| Computer Room | 4-184-1-Q | 8 | .9 |
| Radar Room | 07-160-3-C | 9 | 0 |

As can be seen in Table 1 above, each space or inspection point has a weighted score. This score determines the level of risk associated with the inspection point and its influence on the operational capabilities of the structure. Weighted scores are calculated by multiplying the weighted value of the inspection point with the weighted operational criticality of the inspection point. In the exemplary embodiment, weighted values range from 0.1 to 1 as is illustrated in FIG. 2A. If the condition of an inspection point has a weighted score of 0.1, the condition is little or no impact or influence on the operational capabilities of the inspection point. If the condition of an inspection point has a weighted score of 1, the condition has a major impact or influence on the operational capabilities of the inspection point. For example a fracture in a tank on the ship would have a weighted value of 1 while running rust inside the tank is not of a particular concern and may have a weighted value of 0.1. In the exemplary embodiment, weighted operational criticality range from 1 to 10 with 1 being the least critical and 10 being the most critical. The weighted operational criticality for each inspection point is determined by its location and how critical it is to the operational functionality of the ship. As such, if the fracture requires a prompt and thorough repair and has a weighted score of 1 and a weighted operational criticality of 10, the level of risk is 10 (1×10) and the fracture needs to be repaired immediately. However, if the fracture is minor and has a weighted score of 0.1 and the weighted operational criticality is 10, the level of risk is only 1 (0.1×10). This analysis is repeated for each inspection point. The ranges of 0.1 to 1 and 1 to 10, for weighted values and weighted operational criticality respectively, are default values set within the system. The owner of the ship, or the inspector, can customize these ranges for the particular structure. For example the weighted value can be redefined as 0.9 to 0.99.

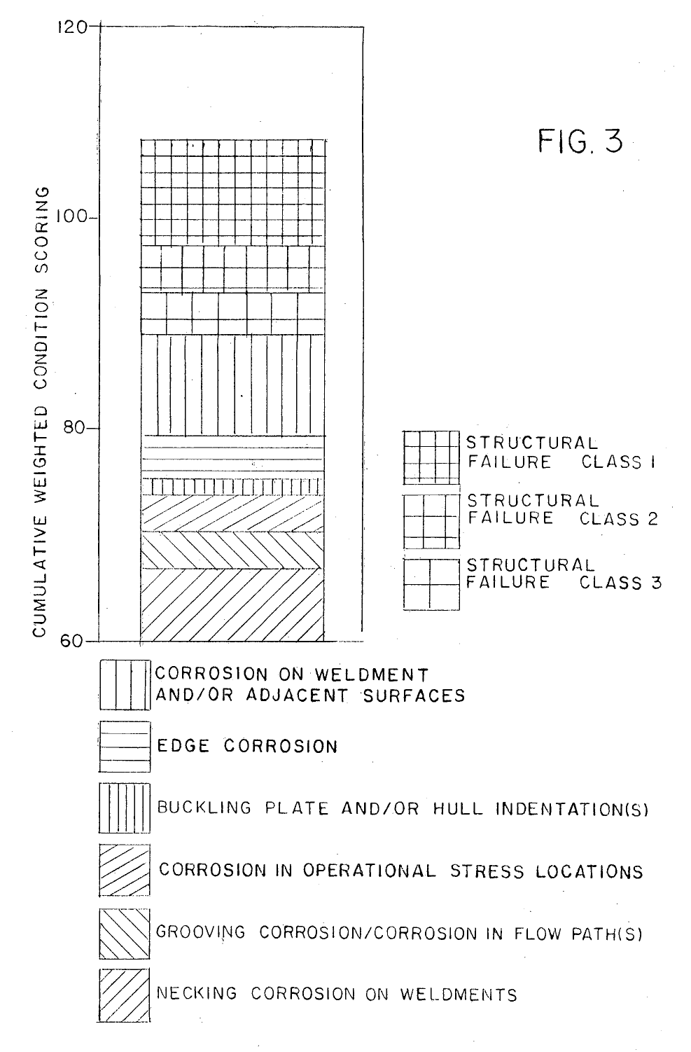

FIG. 3 shows an example of a bar graph illustrating an overview of the maximum level of risk for conditions that are listed on the matrix, such as the matrices in FIG. 2C. This allows an owner/operator to obtain a quick overall view of the risks associated with conditions detected, allowing for a technically correct and consistent determination on the necessity for repair. The condition with the highest cumulative weighted value scoring contains the greatest amount of risk if not repaired. The bar graph illustrates the maximum level of risk to be 110 with 10 possible conditions. However, the maximum level of risk is based on the conditions shown. Additional conditions can be added to the bar graph increasing the maximum level of risk.

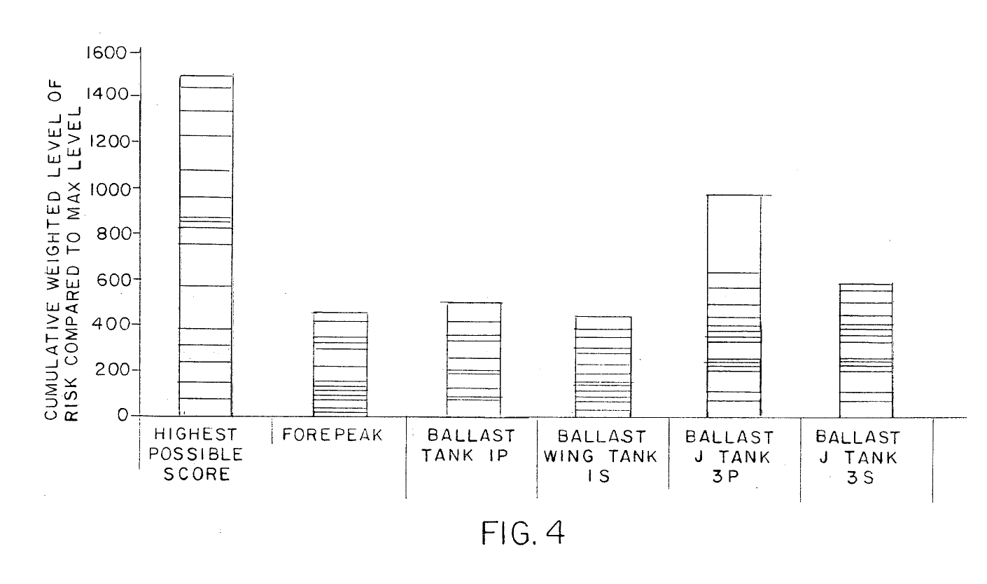

FIG. 4 illustrates another way of displaying the associated risks with the conditions found on the structure. In FIG. 4, a bar graph illustrates a maximum level of risk for conditions that can be found on a ship compared to the surveyed or inspected level of risk of each inspection point. Each inspection point, as well as the maximum level of risk, is broken into several segments. As with FIG. 3, each segment represents a different anomaly or condition found with each inspection point. By displaying the associated risks in the form of a bar graph illustrating a maximum level of risk compared to the inspected level of risk of an inspection point, an owner/operator can quickly glance at the bar graph and determine the inspection point with the cumulative weighted level closest in value to the maximum level of risk that requires immediate repair. In an alternative embodiment, the bar graph can illustrate a comparison of that maximum level of risk for conditions associated with each inspection point with the inspected level of risk for each inspection point.

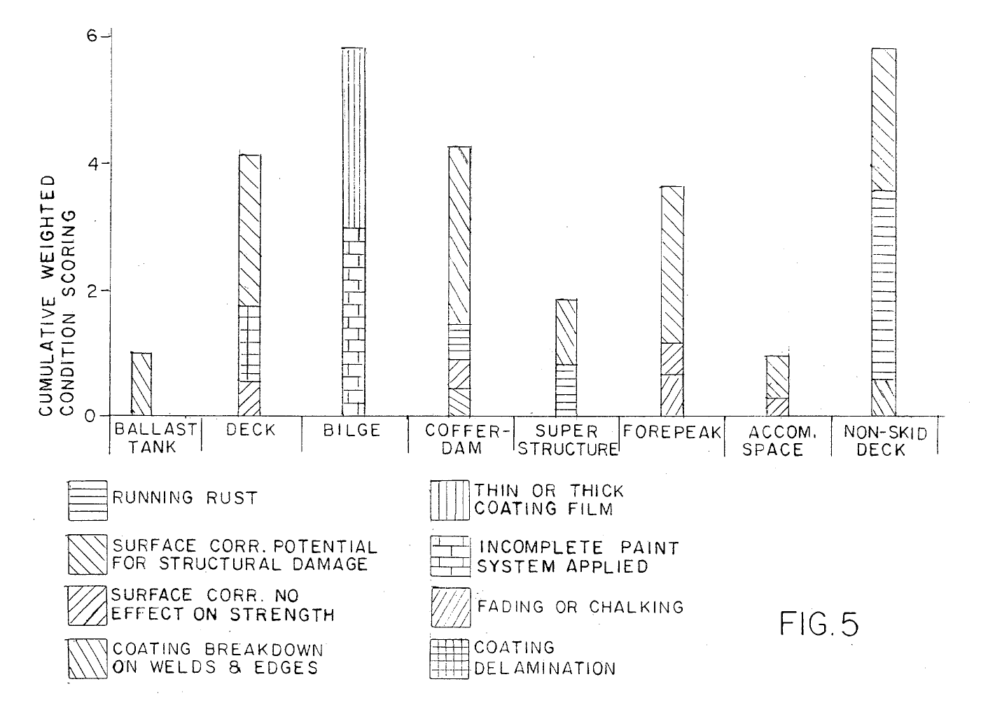

FIG. 5 illustrates yet another way to display the result of the survey. A bar graph illustrates the anomalies and cumulative weighted condition scoring associated with the conditions found for each inspection point. The condition with the highest cumulative weighted condition scoring contains the greatest amount of risk if not repaired. As with the other ways of displaying the results, displaying the results in this form allows an owner/operator to quickly determine which condition or anomaly will cause the greatest amount of risk to the structure if not repaired. Furthermore, the bar graph details the conditions found for each particular inspection point. For example, the bildge has an incomplete paint system applied as well as a thin or thick coating film. The illustrative length of the condition, such as 3 for the thin or thick coating film, is representative as to the severity of the condition.

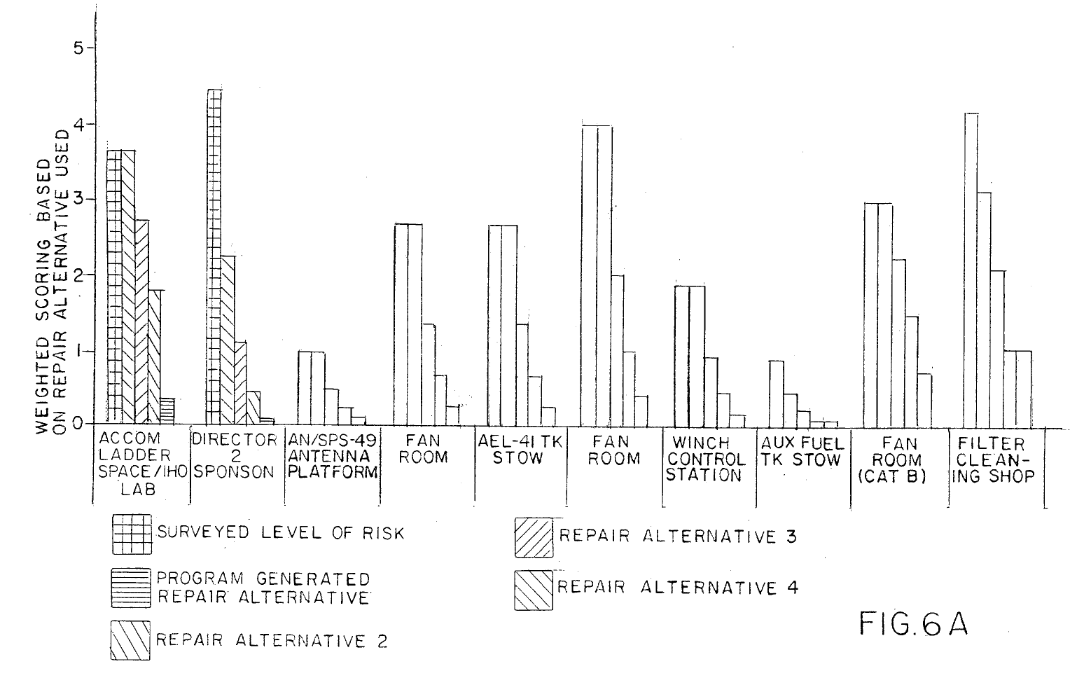

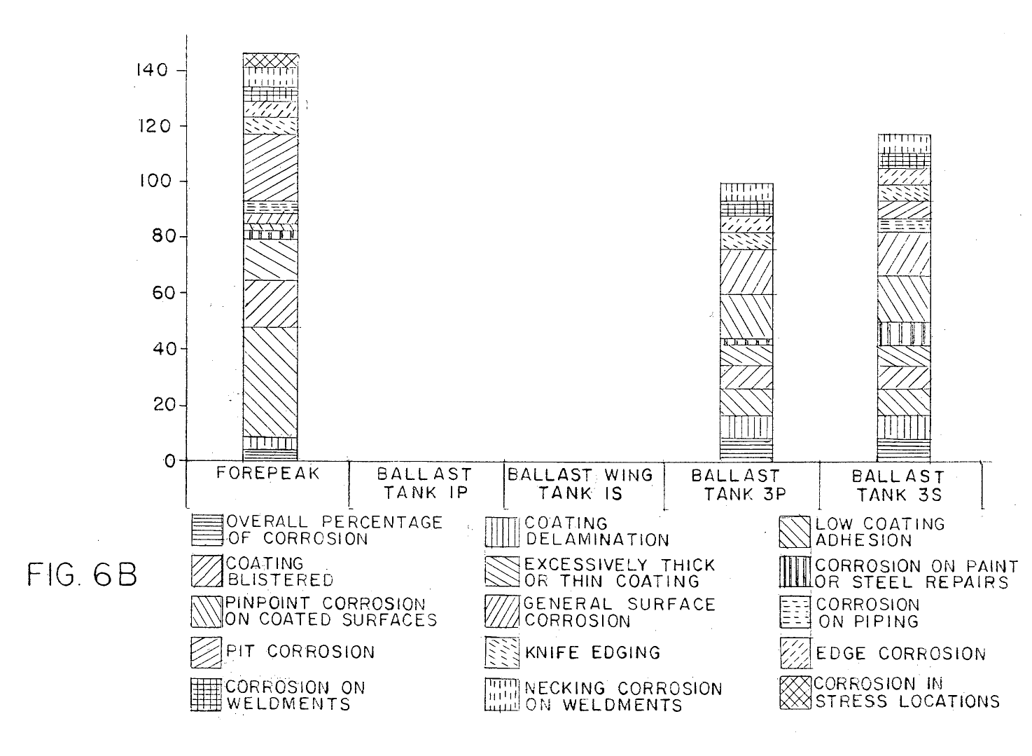

FIG. 6A illustrates yet another way to display the result of the survey or inspection. In FIG. 6A, a bar graph comparing the weighted level of risk for potential conditions that can be found in the inspection points with the completion of repairs indicated in alternatives 1-4 is shown. As described previously, the system analyzes the data for each inspection point and generates several alternative work packages or repairs. Each alternative is associated with a different level of risk as well as cost to the owner to complete the repairs. By displaying the comparison weighted level of risk for potential conditions to the completion of repairs, the owner/operator, can obtain a quick overall view of the reduced risk after completing the repairs in each alternative. This overall view allows the owner/operation to quickly assess which alternative should be chosen.

FIG. 6B shows a bar graph illustrating the level of risk associated with the conditions of each inspection point after completing the repairs in alternative 1. For example, the forepeak represents the degree of risk after alternative 1 is completed. With the forepeak, some intermediate repairs have taken place, however full repair of the anomalies has not been completed and there is still some associated risk with the forepeak. On the other hand, completing the repairs associated with alternative 1 has completely repaired the anomalies associated with the ballast tank 1P and the ballast wing tank 1S reducing the risk to 0.

Although an exemplary embodiment of the invention has been described above by way of example only, it will be understood by those skilled in the field that modifications may be made to the disclosed embodiment without departing from the scope of the invention, which is defined by the appended claims.

WE claim:

1. A process of performing standardized risk assessment comprising the steps of:
providing general characteristics of a structure and storing the general characteristics in a database;
selecting information about the structure from a plurality of data fields in a drop down menu;
generating a plurality of conditions that can be found on the structure, the plurality of conditions determined by the general characteristics and the information about the structure;
presenting the plurality of conditions in the form of drop down menus, the plurality of conditions indicating a status of at least one inspection point;
selecting a condition of the at least one inspection point by selecting a result in the drop down menu;
assigning an assessed value to the condition; and
determining a risk value based on the degree of damage and location of the at least one inspection point.

2. The process of claim 1, further comprising the step of populating additional drop down boxes based upon the selection of the condition.

3. The process of claim 1, wherein the condition selected best categorizes the status of the at least one inspection point.

4. The process of claim 1, wherein each inspection point of the at least one inspection point is compared on an objected normalized standard.

5. The process of claim 2, further comprising the step of calculating a weighted score by multiplying the assessed value of the at least one inspection point with a weighted operational criticality of the at least one inspection point.

6. The process of claim 5, wherein the weighted value of the at least one inspection point is determined by the result of the condition; and
wherein the weighted operational criticality for the at least one inspection point is determined by the location of the at least one inspection point and how critical it is to operational functionality of the structure.

7. The process of claim 6, wherein the weighted score represents an associated risk of the at least one inspection point; and
wherein the associated risk is displayed by a specific area of the structure.

8. The process of claim 7, wherein the risk assessment is displayed in a table by order of precedence; and
wherein the order of precedence determines which of the each of the at least one inspection points requires immediate repair.

9. The process of claim 7, wherein the risk assessment is displayed in the form of a bar graph.

10. The process of claim 7, wherein the owner of the structure determines a range of numbers for the weighted value.

11. The process of claim 7, further comprising the step of selecting standards and regulations that the standardized risk assessment uses to determine the weighted valued.

12. The process of claim 11, wherein the standards and regulations used are determined by classification of the ship.

13. The process of claim 1, wherein the structure is a ship.

14. The process of claim 1, wherein the structure is an airplane.

15. The process of claim 12, further comprising the step of generating at least one alternative to correct the condition.

16. The process of claim 15, wherein each of the at least one alternative poses a different level of risk, time and cost associated with correcting the condition.

17. The process of claim 1, wherein a personal digital assistant is utilized to present the plurality of conditions; and
wherein the personal digital assistant downloads the general characteristics of the structure to perform risk assessment
